(19) United States
(12) Patent Application Publication
(10) Pub. No.: US 2024/0386204 A1
(43) Pub. Date: Nov. 21, 2024

(54) System and Method to Generate and Enhance Dynamic Interactive Applications from Natural Language Using Artificial Intelligence

(71) Applicant: Brainweber Inc, Tampa, FL (US)

(72) Inventor: Sivashankar Sangarapillai, Tampa, FL (US)

(73) Assignee: Brainweber Inc, Tampa, FL (US)

(21) Appl. No.: 18/663,662

(22) Filed: May 14, 2024

Related U.S. Application Data
(60) Provisional application No. 63/502,390, filed on May 15, 2023.

(51) Int. Cl. G06F 40/284; G06F 16/26

(52) U.S. Cl. CPC G06F 40/284; G06F 16/26

(57) ABSTRACT

System and methods for generating and enhancing dynamic interactive applications using artificial intelligence include a system that receives requirements for an application in natural language and uses artificial intelligence to generate a functional application. Such generated application is then continuously enhanced and adjusted with additional user and system feedback provided through natural, markup, programming, and domain-specific languages.

### BACKGROUND OF THE INVENTION

A dynamic interactive application consists of one or more application screens referred to as dashboards. Each dashboard consists of zero or more elements of widgets, filters and actions arranged in an optimal way for enhanced user experience. Dashboards receive data from configured data sources in real time and allow users to update data through action elements. Input and output links provide discovery and connecting mechanism to each dashboard. One or more layouts can be specified with customizable themes and device optimized arrangement of elements within the dashboard. Key Performance Indicators (KPIs) are defined and tracked within the application. Jobs perform automated actions such as data import, export, and transformations that are pre-configured by users. Currently professional software developers are employed to build such an application. Though some processes can be automated, generating and enhancing a complete high-quality application through user interaction in natural language continues to be a challenge.

Prior systems have various types of application generation as listed below:

Low-code/no-code platforms: Platforms, such as Microsoft® Power Apps, Google® AppSheet, Domo, and Mendix allow users to create applications with minimal coding through a graphical user interfaces. These platforms interpret parts of application requirements but typically require human input to guide and refine the process and often the generated applications are platform specific and proprietary and cannot be customized or maintained outside the generator ecosystem.

AI-assisted development tools: Tools like GitHub Copilot, which is powered by OpenAI's Codex assist developers by suggesting code snippets and entire functions based on the comments and code context provided by the user. These tools help speed up the development process but still require developers to understand coding and software design.

Domain-specific AI solutions: There are artificial intelligence services tailored to specific industries (like healthcare, finance, and logistics) that offer specialized tools and frameworks. These solutions automate certain domain-specific tasks but usually cannot generate a full end-to-end application.

IDE plugins and enhancements: Many modern integrated development environments (IDEs) incorporate artificial intelligence-based features to improve code quality, detect errors proactively, and suggest optimizations. Examples include IntelliJ IDEA, Visual Studio, and Eclipse, which have various artificial intelligence plugins.

Prototype generation tools: Some tools focus on translating design and requirements into prototypes or minimal viable products (MVPs), which are then developed into full-scale applications. Tools like Adobe® XD with its auto-animate feature, and Figma's® interactive components help create dynamic prototypes but still require manual effort to convert into fully functional applications.

What is needed is a system that will generate and enhance dynamic interactive applications in natural language using artificial intelligence.

### SUMMARY OF THE INVENTION

An AI based system and methods are disclosed to generate dynamic interactive applications from a natural language input. The system takes requirements for creating and enhancing an application in a natural language format and sub-divides the requirements for improving the application that is generated.

Requirements are analyzed to identify the data sources that need to be queried and updated by the application. Requirements are further analyzed and enriched with additional information from domain-specific databases.

Meta data from identified data sources and enriched requirements are combined to generate the final requirements that can be fed to an AI domain-specific language code generator. This summarization process may be repeated multiple times until the requirements are complete and can be handled by the AI processor without exceeding AI processing capabilities such as token limits in a large language model-based domain-specific language code generator. Special attention is paid to eliminating or minimizing information loss during the summarization process.

The AI domain-specific language code generator generates the application in a domain-specific language. The domain-specific language completely and accurately describes the application in a manner so that the application generator can understand and generate the functional application. Careful attention is paid when creating the domain-specific language to minimize the number tokens needed to fully describe the functional application. The domain-specific language is designed in such a way the AI can generate the full or a portion of the application when required to do so due to speed or other technical limits of the AI domain-specific language code generator.

AI generated application that conforms to the domain-specific language is fed to the application generator to generate the functional application that can be deployed to end users. Before the application is deployed to end users, automated system reviews and manual user reviews are performed to make sure the AI generated application satisfies the initial and subsequent requirements. If needed, additional user and system requirements are fed to the requirements summarizer to repeat the process again to generate an updated version of the application.

Version control is used to manage revisions of the application and to carefully select aspects of the revisions for a usable and deployable version of the application. This process is continued throughout the life of the application to continue enhancing the application using the above-mentioned system and methods.

In one embodiment, a method for generating and enhancing dynamic interactive applications is disclosed. The method includes receiving requirements for creating and/or enhancing an application. The requirements are in a natural language and/or multimedia format and are received by way of user interfaces. The user interfaces include web pages, application interfaces, image input, video input and/or voice input. The requirements are analyzed using artificial intelligence technologies including vector search, machine learning, natural language processing, and large language models to identify data sources that are necessary for querying and updating by the application, wherein the data sources include relational and non-relational databases, data lakes, data marts, data warehouses, data streams, and/or integrations. Next, the requirements are enriched with additional information from domain-specific databases containing metadata related to the data sources, thereby creating enriched requirements and the enriched requirements and metadata from the data sources are summarized to generate final requirements in an artificial intelligence optimized format, iteratively summarizing the enriched requirements until the enriched requirements are within processing capabilities of artificial intelligence including token limits of a large language model-based domain-specific language generator, while minimizing information loss. Next, the application is generated in a domain-specific language using a domain-specific language generator using the artificial intelligence based on the final requirements, wherein the domain-specific language accurately and completely describes the application for understanding and generation by an application generator and the domain-specific language is designed minimizing a number of tokens needed for describing the application to conform to processing capabilities of the artificial intelligence. The application is deployed for end user use on various platforms, the various platforms including web platforms, desktop platforms, virtual reality/augmented reality platforms, and mobile platforms. Once deployed, the application is reviewed through automated system and manual user reviews, ensuring that the application meets the requirements. Feedback comprising user requirements and system requirements are accepted for deploying of an updated versions of the application through a feedback loop, wherein the feedback loop is provided in various formats including natural language, encoded, markup, domain-specific, or programming languages. Using version control, the application revisions are managed and aspects of the feedback are selected for a usable and deployable version of the application. The application is continuously enhancing by repeating the above steps with new requirements or updated requirements.

In another embodiment, a system for generating and enhancing dynamic interactive applications includes a requirements receiver configured to receive application requirements in a natural language format from user interfaces. The user interfaces include web pages, application interfaces, and voice input. An artificial intelligence-based requirements pre-processor analyzes and splits requirements using artificial intelligence technologies. The artificial intelligence technologies comprise machine learning, natural language processing, and large language models, to identify data sources that are relevant. A domain-specific database enhancer enriches the requirements with domain-specific metadata from databases containing information related to the data sources that are identified. A requirements summarizer uses the artificial intelligence technologies to create summarized requirements within artificial intelligence processing limits. The requirements summarizer iterates multiple times to ensure the requirements meet an artificial intelligence processor token limit without significant information loss. An artificial intelligence technologies domain-specific language code generator creates an application in a domain-specific language based on the summarized requirements. The artificial intelligence technologies domain-specific language code generator uses a multimodal large language model that understands the domain-specific language and generates domain-specific language instructions for application development. An application builder converts the domain-specific language instructions into a deployable functional application including a dashboard configuration database and stores details related to dashboard configurations, widgets, filters, actions, and links and a version control system manages revisions of the application and selects aspects of the revisions for a usable and deployable version of the application. A feedback receiver processes additional user requirements and system requirements to enhance the application, the feedback receiver accepts the requirements in various formats including natural language, encoded, markup, domain-specific, and/or programming languages for comprehensive application enhancements based on wide-ranging feedback types.

### BRIEF DESCRIPTION OF DRAWINGS

The invention can be best understood by those having ordinary skill in the art by reference to the following detailed description when considered in conjunction with the accompanying drawings in which:

FIG. 1 is a block diagram of a system for generating dynamic interactive applications in natural language.

FIG. 2 is an example of an input user interface used to collect application requirements from a user.

FIG. 3 is an example of a domain-specific language definition that can be used by the AI domain-specific language code generator.

FIG. 4 is an example of a dashboard configuration generated by the system.

FIG. 5 is an example of a widget configuration generated by the system.

FIG. 6 is an example of a filter configuration generated by the system.

FIG. 7 is an example of a functional application dashboard generated by the system.

FIG. 8 is an example of a linked sub dashboard generated by the system.

FIG. 9 is an example of finalized requirements fed to the AI domain-specific language code generator.

FIG. 10 is an example of an AI generated domain-specific language used to build the desired application.

FIG. 11 is an example of a KPI configuration generated by the system.

FIG. 12 is an example of a job configuration generated by the system.

FIG. 13 is an example of a domain-specific language definition that can be used by the AI domain-specific language generator.

FIG. 14 is an example of an input user interface used to adjust application requirements after the application was generated by the system.

FIG. 15 is an example of building an inventory management application using the system for generating dynamic interactive applications.

FIG. 16 is an example a dashboard when building the inventory management application using the system for generating dynamic interactive applications.

FIG. 17 is an example set of instructions used when building the inventory management application using the system for generating dynamic interactive applications.

FIG. 18 is an example of the artificial intelligence agents used when building the inventory management application using the system for generating dynamic interactive applications.

FIG. 19 is an example breakdown of agent tasks used when building the inventory management application using the system for generating dynamic interactive applications.

FIG. 20 is an example domain knowledge requirements used when building the inventory management application using the system for generating dynamic interactive applications.

FIG. 21 is an example of datasets that will be needed when building the inventory management application using the system for generating dynamic interactive applications.

FIG. 22 is an example of agent skills when building the inventory management application using the system for generating dynamic interactive applications.

FIG. 23 is an example of specialized agents used when building the inventory management application using the system for generating dynamic interactive applications.

FIGS. 24A, 24B, 24C, and 24D are examples of artificial intelligence agent instructions and responses used when building the inventory management application using the system for generating dynamic interactive applications.

### DETAILED DESCRIPTION OF THE INVENTION

Reference will now be made in detail to the presently preferred embodiments of the invention, examples of which are illustrated in the accompanying drawings. Throughout the following detailed description, the same reference numerals refer to the same elements in all figures.

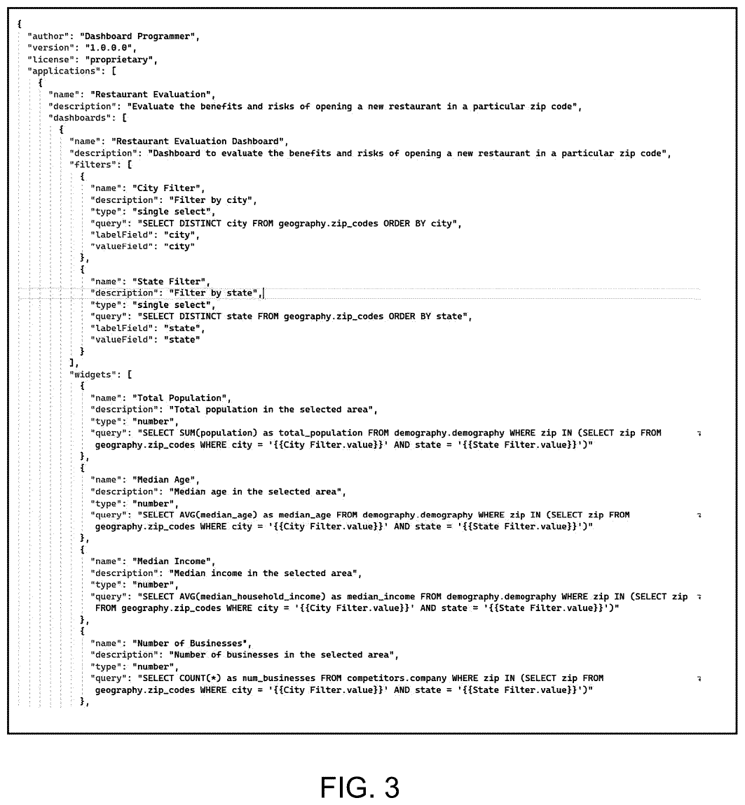

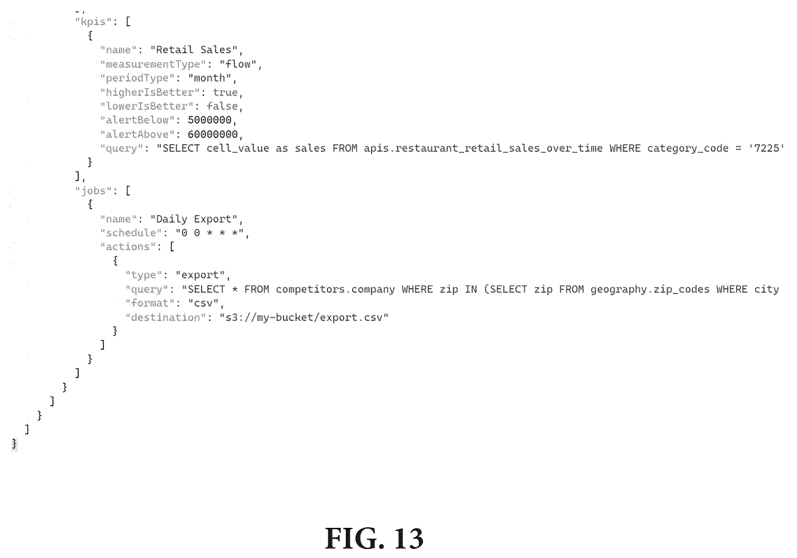

Referring to FIG. 3 and FIG. 13, an example of a domain-specific language (DSL) is shown. The domain-specific language defines the following entities and their relationship within the application to generate and maintain the dashboards and related features:
a. Dashboard-Dashboards are user interfaces that contain a collection of widgets, filters, actions and links arranged in an optimal way to receive and update information.
b. Widget-Widgets contain a collection of read-only or editable elements. These elements include, but are not limited to, text, html, image, chart, graph, map, and input field.
c. Filters-Filters allow all or part of the information displayed in the dashboard to be changed based on their value. Filters can be in various formats including but not limited to button, button group, plain text, typeahead text, single select, multi select, image select, switch, radio button, and check box.
d. Action-Actions allow the user to perform actions on the dashboard user interface that may result in the change of user interface or data. Actions can be triggered by input element that may contain button, button group, plain text, typeahead text, multi-line text, single select, multi select, image select, map select, switch, radio button, and check box.
e. Link-Links provide input and output paths to a dashboard. Input links define how the dashboard can be accessed. Output links provide a path to access other dashboards that are related to the current dashboard.
f. Data-Data is rendered in the dashboard through UI elements such as widgets, filters, and actions. Data can be static or dynamic and can be obtained from multiple sources through database queries and API requests to name a few.
g. Layout-Layout defines the arrangement of widgets, filters, actions, and links in a dashboard. Multiple layout configurations can exist in per dashboard each optimized for specific device type and form factor.
h. Job-A job is a collection of job actions. Each job action defines a step that can be executed in the system to accomplish a task such as importing, transforming, or exporting data.
i. KPI-A key performance indicator can be used by the system to define and measure goals.

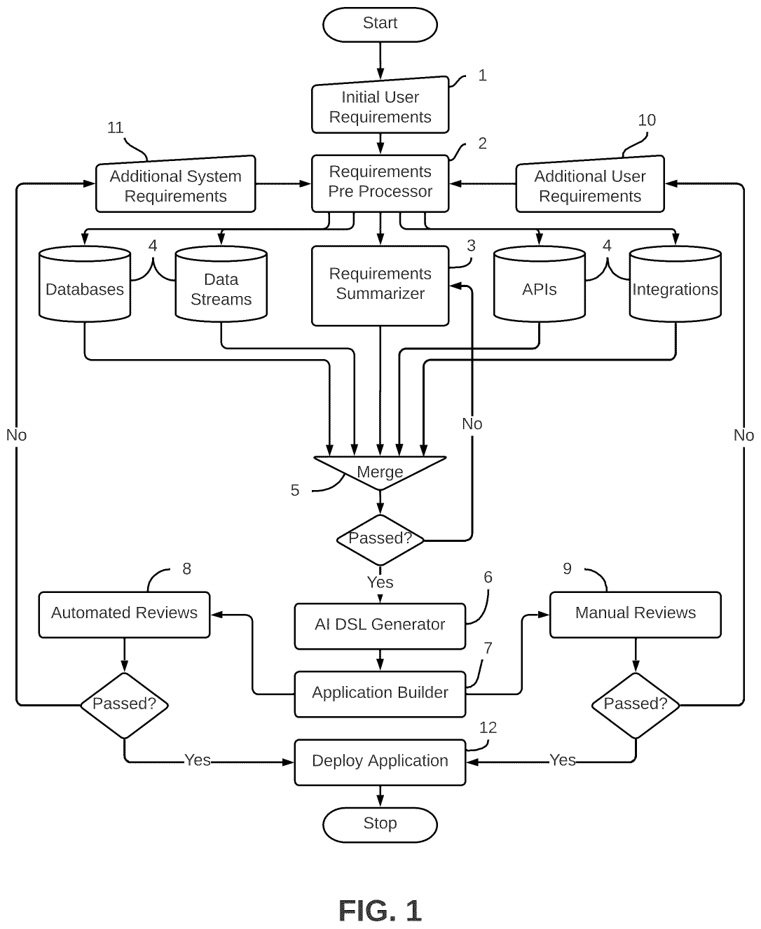

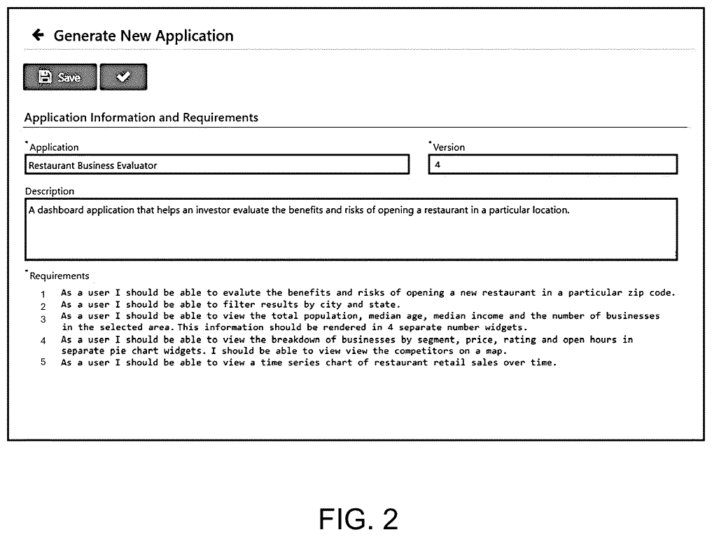

Referring to the flow chart of FIG. 1, user interfaces Jan. 9, 2010 receive new or updated requirements in a natural language. Examples of such user interfaces include, but are not limited to, web pages, application interfaces, video and voice inputs. FIG. 2 shows an example of such a user interface where the user can type in the full requirements of the application in a natural language. An additional user interface 10 is provided to receive additional requirements in natural, encoded, markup, domain-specific or programming languages. An example of such requirements includes, but is not limited to, a request for database query optimization based on automated query plan and performance review (e.g., automated review 8).

A requirements pre-processor 2 uses AI technologies including but not limited to ML, NLP and LLM to identify data sources that need to be connected to the desired applications. This requirements pre-processor is used to split up a large requirements text in natural language into smaller chucks and to find the most relevant data sources 4 and additional contextual information to be fed to the requirements summarizer 3. Requirements enrichment databases include but not limited to structured query language (sql), non-tabular databases (nosql), search and vector databases that contain domain-specific information and data source meta data. The data sources 4 include, but not limited to, relational and non-relational databases, data lakes, data marts, data warehouses, data streams, APIs and integrations.

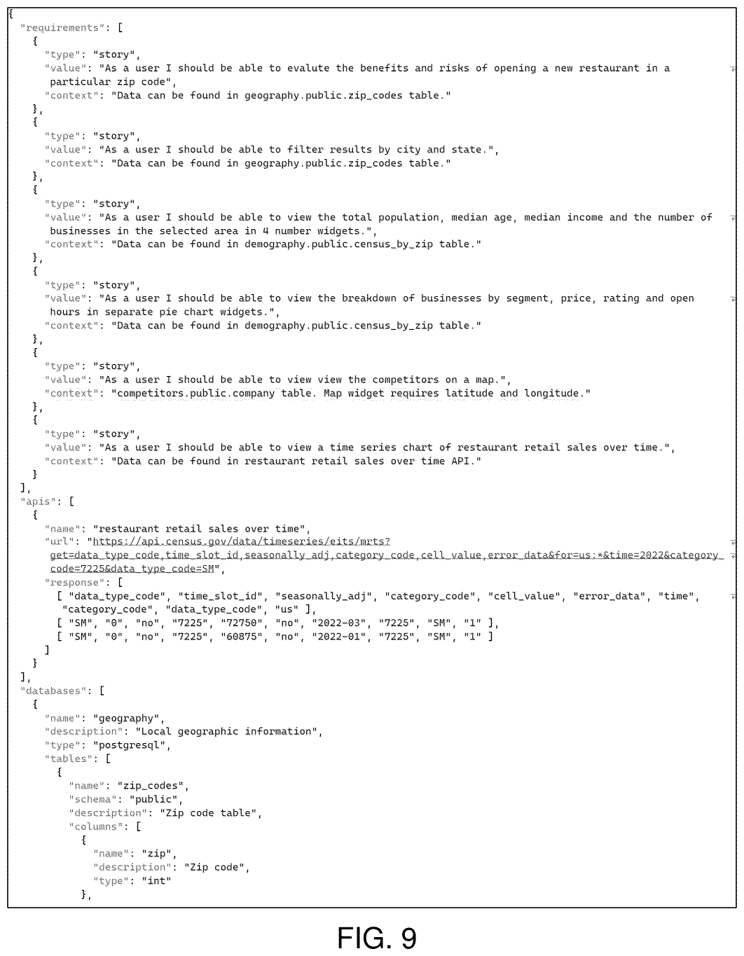

A requirements summarizer 3 uses any artificial intelligence (AI), Natural language processing (NLP), and/or large language model (LLM) based techniques to summarize user requirements in an AI optimized format so that requirements do not exceed the maximum number of tokens that can be accepted by the generative AI such as a multimodal large language model. In some embodiments, the summarizer iterates multiple times to achieve the needed level of summarization. An example of generated summary requirements is shown in FIG. 9.

Merge module 5 combines meta data from identified data sources 4 and summarized requirements from requirements summarizer 3 to generate a final optimized request that can be fed to the artificial intelligence domain-specific language code generator 6. The merge module 5 validates the final optimized request to make sure it conforms to requirements of the artificial intelligence domain-specific language code generator 6 such as token limits, completeness, and compatibility. If the validation fails, the information is sent back to the requirements summarizer 3 so that it generates an updated requirement that will pass the validation before fed to the artificial intelligence domain-specific language code generator 6.

The artificial intelligence domain-specific language code generator 6 takes the merged and validated requirements and generates the application in a domain-specific language. An example of such an artificial intelligence domain-specific language generator 6 is constructed using a multimodal large language model such as GPT-4. Generative Pre-trained Transformer 4 is a multimodal large language model created by OpenAI.

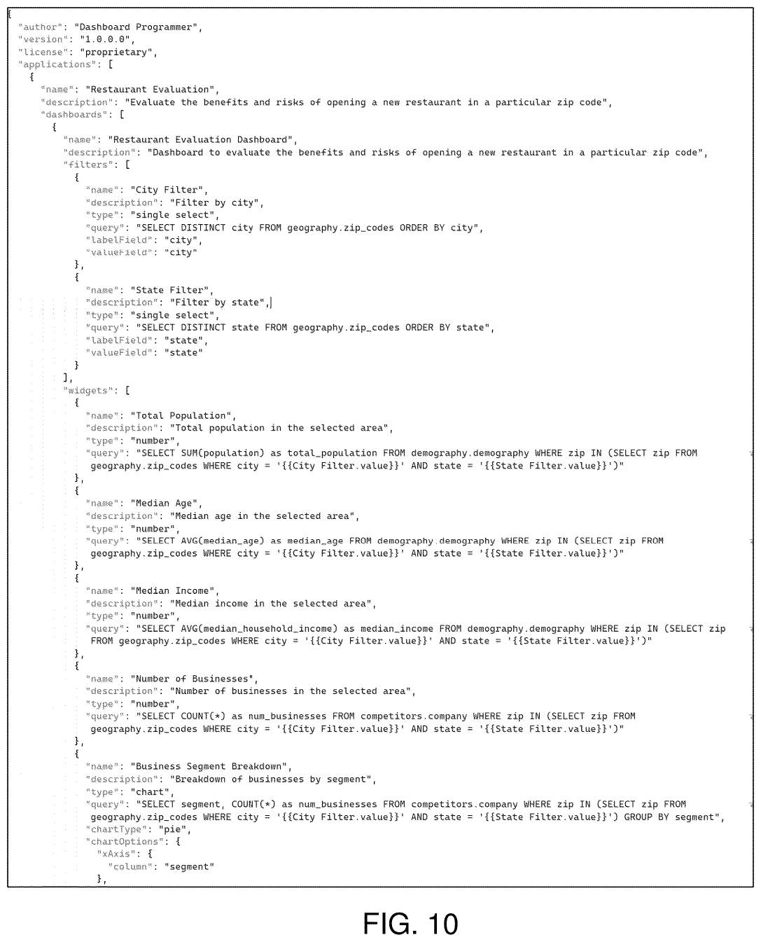

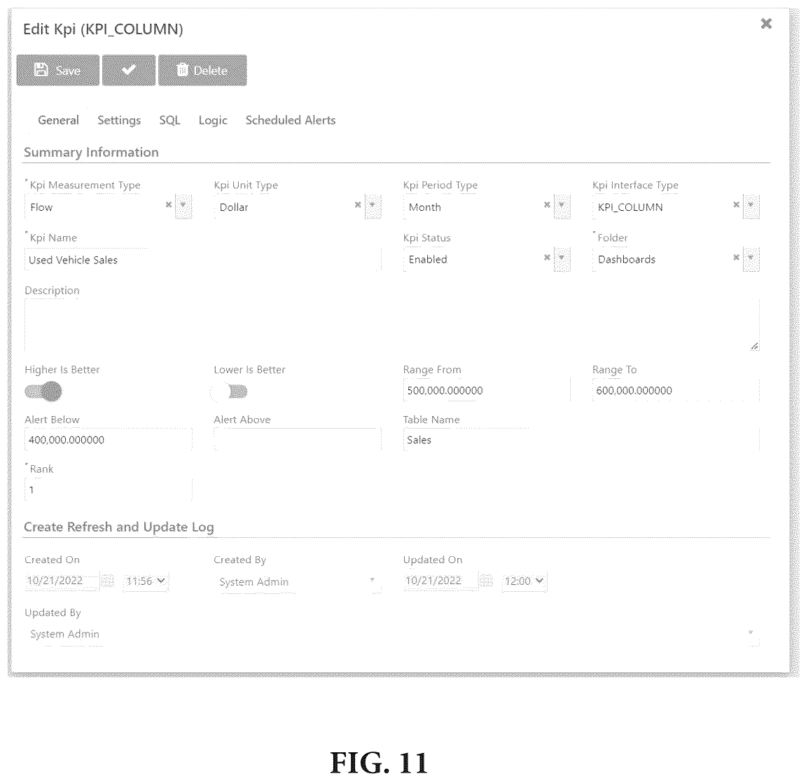

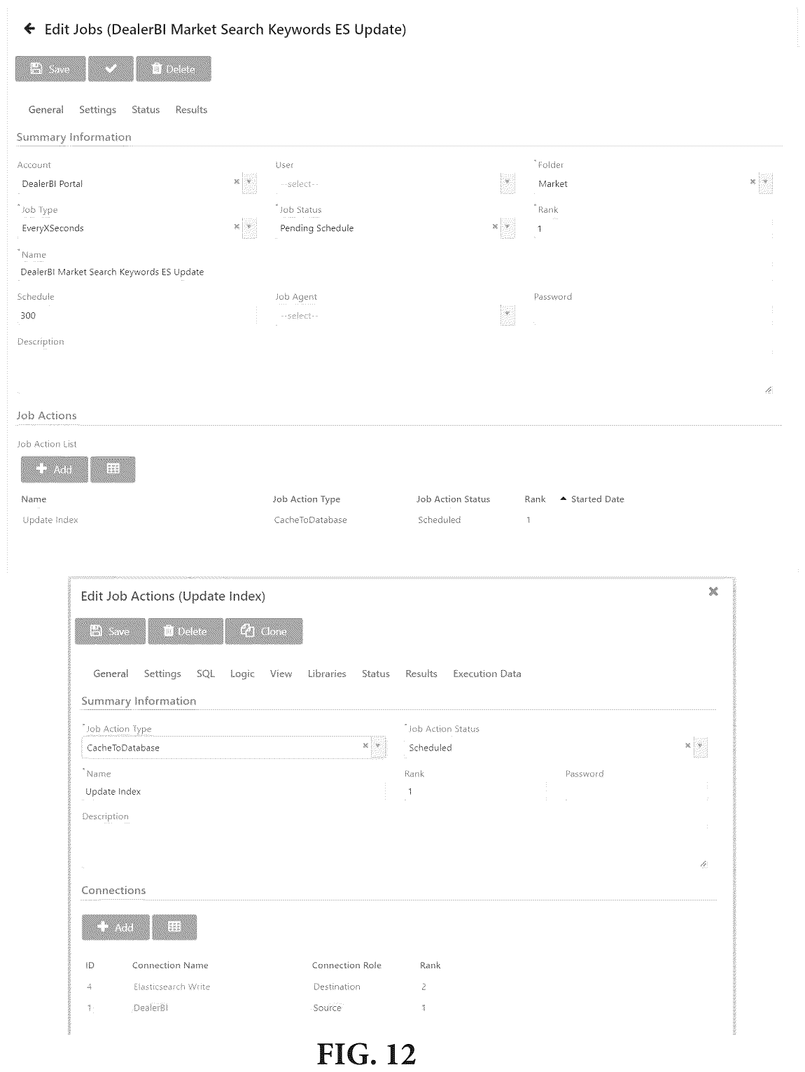

Careful attention is paid to make sure summarized requirement does not exceed the known limitations of the artificial intelligence domain-specific language code generator 6. Careful adjustments are made to the configuration of the artificial intelligence domain-specific language code generator 6 to ensure generated domain-specific language code conforms to the application generator requirements. An example of domain-specific language code is provided in FIG. 10.

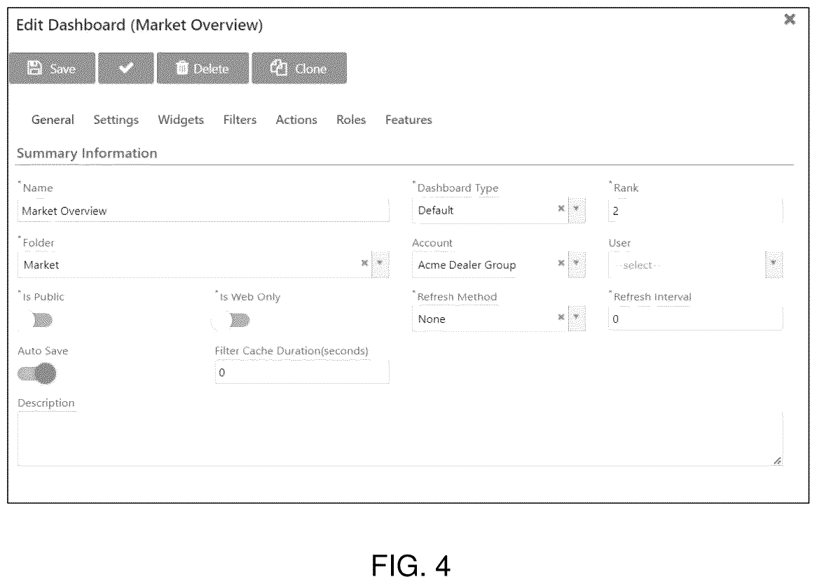

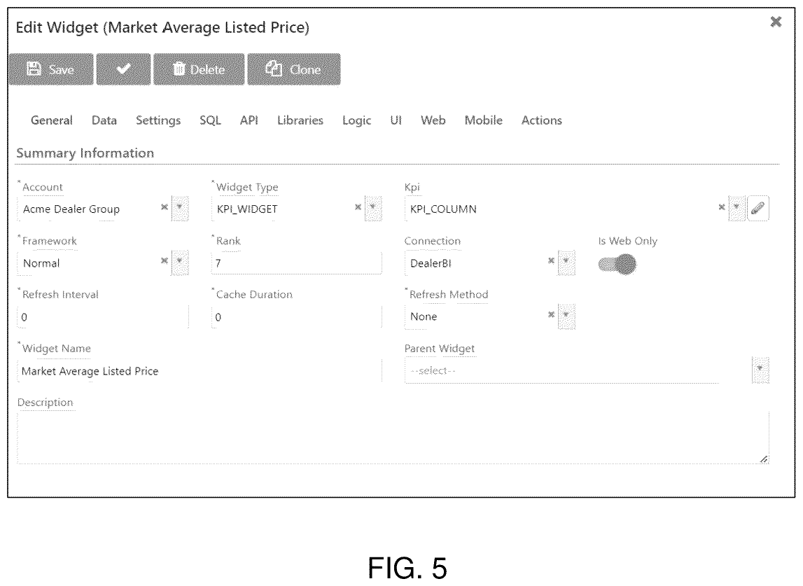

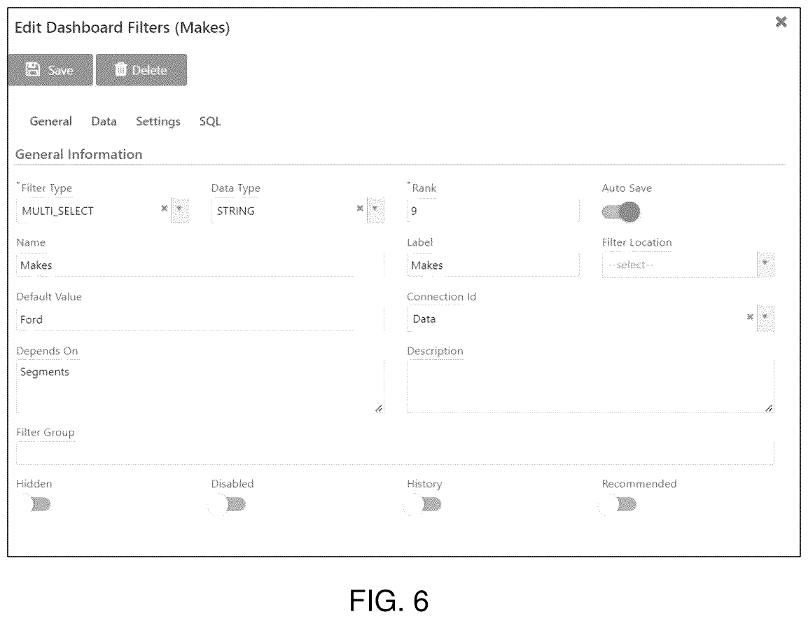

Application builder 7 converts the generated domain-specific language code into a functional application. The application builder 7 imports the data from domain-specific language into a dashboard configuration database that contains tables to store configuration details related to dashboards, widgets, filters, actions, and links. An example of such configurations is shown in FIG. 4, FIG. 5, and FIG. 6. Application builder 7 combines configuration data and application user interface frameworks to generate functional applications that can run on web, desktop, and mobile platforms to name a few.

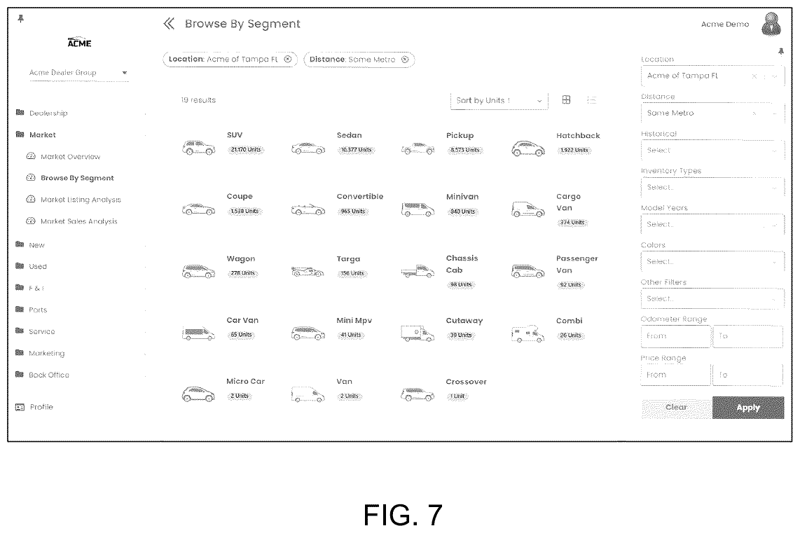

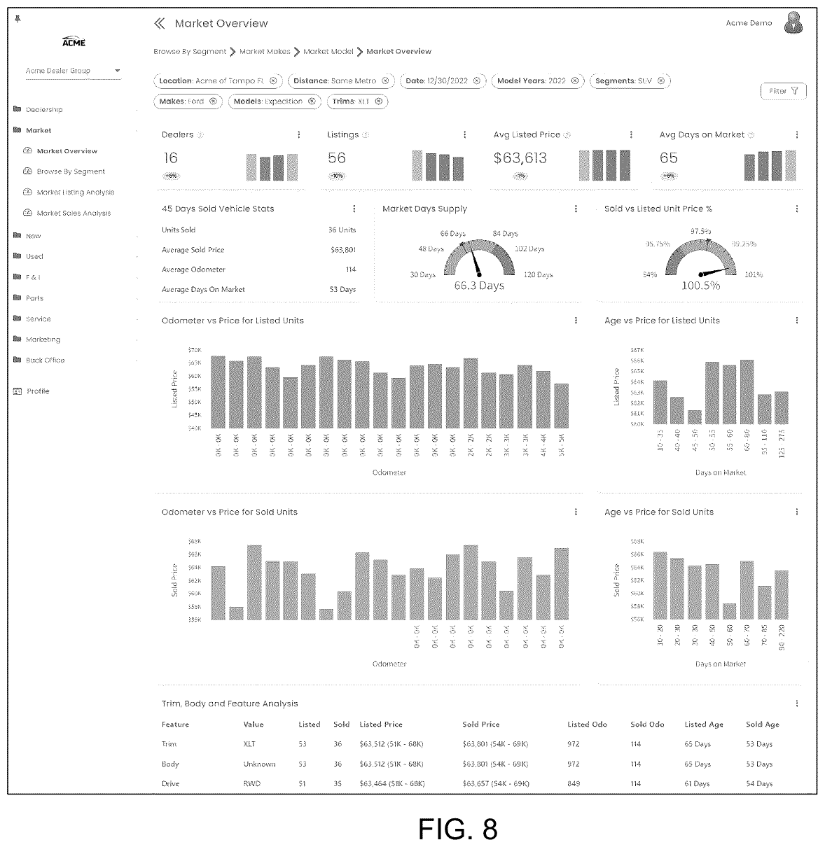

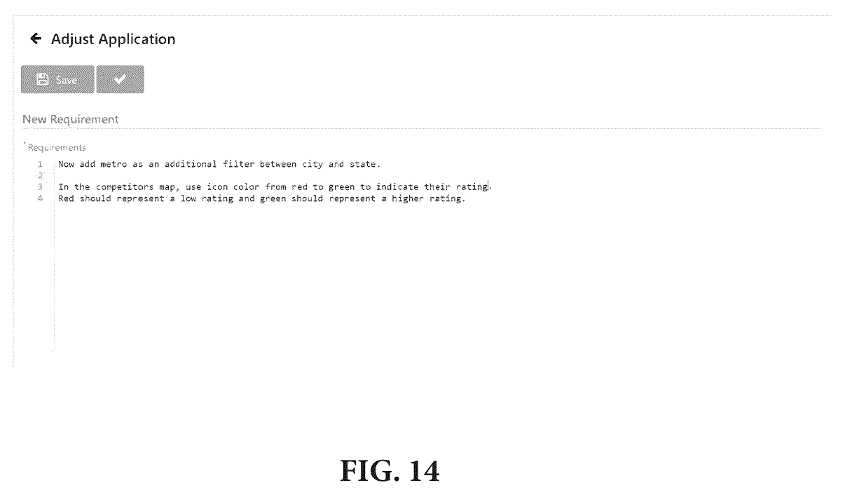

Generated application is deployed (deployed application 12) to servers. The deployed application 12 satisfies the requirements 1. An example of a deployed dashboard application is shown in FIG. 7 and FIG. 8. In some embodiments, end users further fine tune the generated dashboard as shown in FIG. 14.

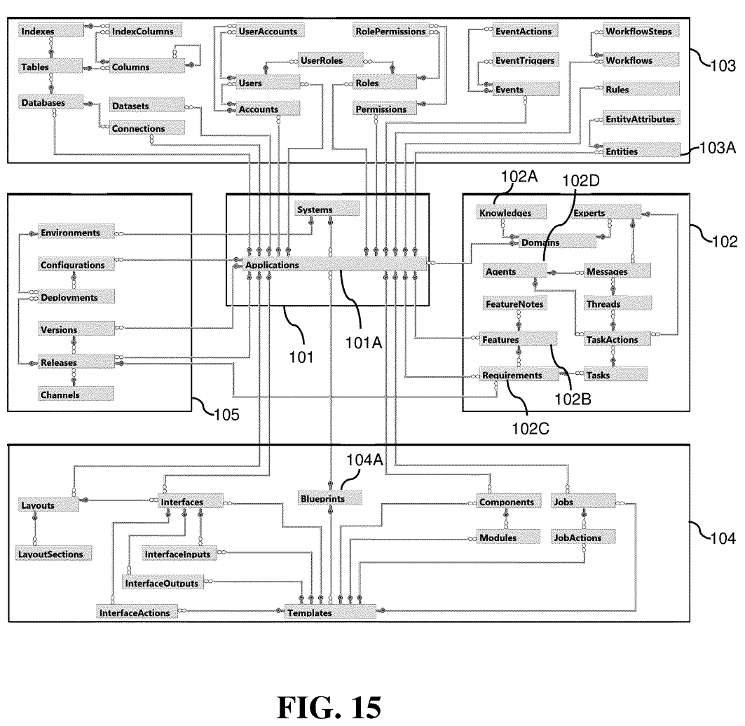

Referring to FIG. 15, an example of building an inventory management application using the system for generating dynamic interactive applications is shown.

First a system record is created in the application builder 101 for the team of users who will contribute to the creation and enhancement of the exemplary Inventory management system (IMS). One or more environments and related deployment configuration records are created in tables of the merge module 105.

Initial requirements 102 for the inventory management application are provided in the form of written paragraphs (natural language) along with sample screen designs and audio notes. The initial requirements 102 are fed to the application builder 101. All the above information is split into manageable parts (one part per section or page) and indexed in a vector database where similarity search can be performed to retrieve the most appropriate parts of the complete requirements specification. The detailed requirements are summarized using AI/GPT techniques 103. A summary of the requirements along with relevant application blueprints 104A and domain-specific knowledge 102A stored in the database and are fed to the merge module 105 to create the domain-specific language code generator 6 (see FIG. 1). The initial domain-specific language will result in the creation of the following records in the applications table 101A of the application builder 101:
1.) A master application called Inventory Management System.
2.) A sub application called Inventory Management Web Portal for internal users.
3.) A sub application called Inventory Level Dashboard for vendors.
4.) A sub application called Order Status Dashboard for customers.

Related features and requirements are generated and added to the feature table 102B and the requirement tables 102C. At this point AI agents or skills agents 102D validate the generated information. If any inconsistency is found, additional information from the domain-specific knowledge 102A and skills agents 102D are added and fed through the requirements summarizer 3 (see FIG. 1) and revalidated. In some embodiments, validation is performed by human validator.

For each application, a relevant blueprint 104A is selected. A blueprint 104A contains the code templates to convert an application described in a standardized Domain-specific Language (DSL) into functioning application code. An AI domain-specific language generator 6 (see FIG. 1) is used to convert the validated requirements into a detailed domain-specific language document that can be interpreted by the application builder 7 (see FIG. 1). The process is repeated for each application identified. As part of this process, AI agents or skills agents 102D create necessary entity records 103A, master accounts, application roles, database schema, and external connections.

Generated applications are version stamped and deployed to an appropriate testing environment. A set of automated test cases are run to validate the deployed application. A notification is sent to users to initiate any manual review and validation of the application as in FIGS. 1-9. In some embodiments, additional requirements 104A are added, and existing AI generated requirements 104A can be adjusted and the process repeated until the application satisfies the user requirements.

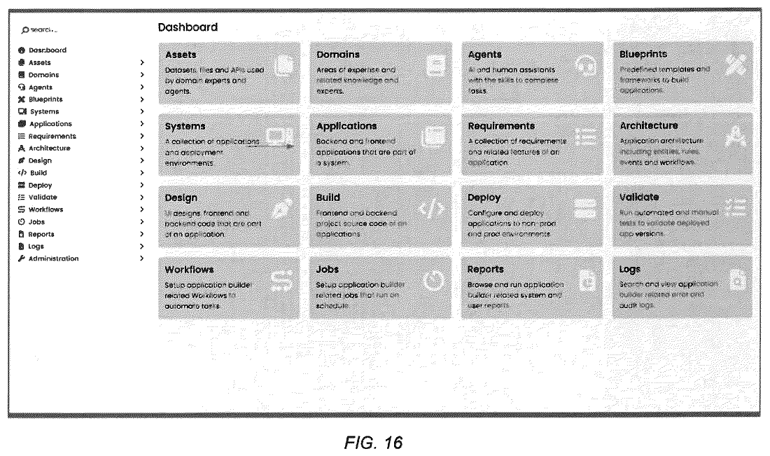

FIGS. 16-24 show a sample set of inputs for generating an inventory management application.

Referring to FIG. 16, an example a dashboard when building the inventory management application using the system for generating dynamic interactive applications is shown. In this, the overall application is sub-divided into sixteen subcategories including assets, domains, agents, blueprints, systems, applications, requirements, architecture, design, build, deploy, validate, workflows, jobs, reports, and logs.

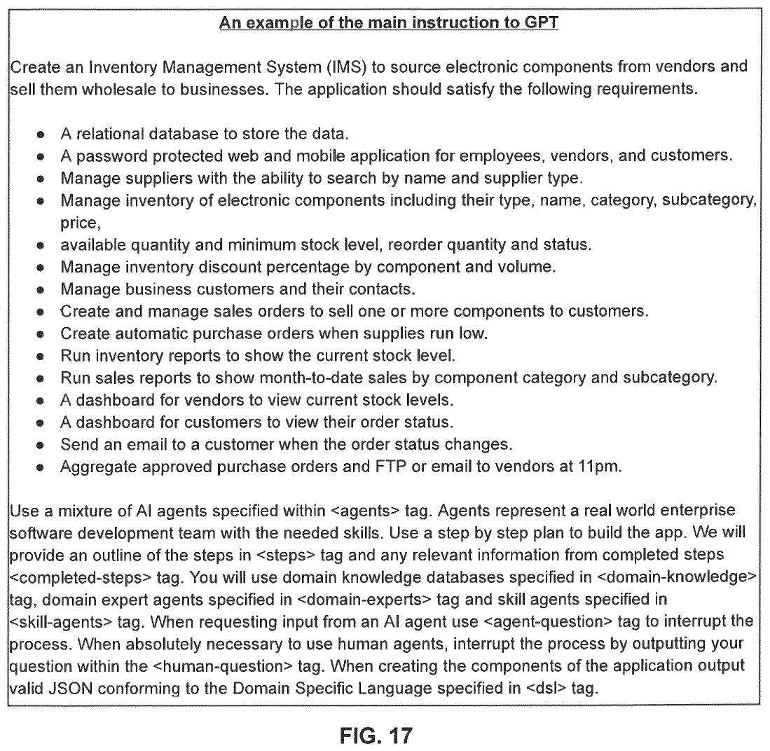

Referring to FIG. 17, an example set of instructions used when building the inventory management application using the system for generating dynamic interactive applications is shown. For example, the inventory management system will require a database to store inventory data and password protection for users such as employees, suppliers, and customers.

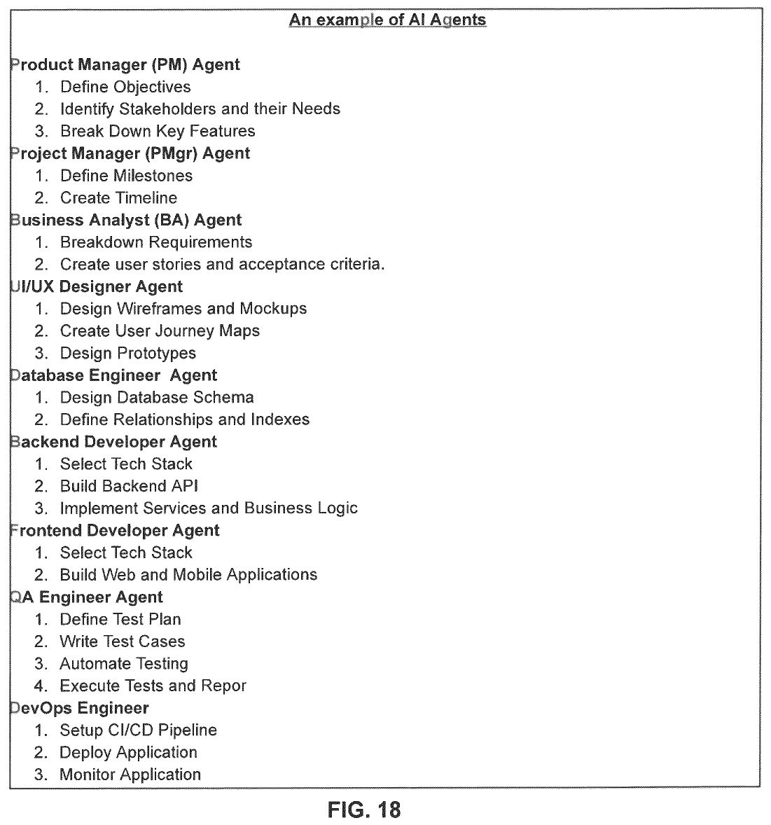

Referring to FIG. 18, an example of the artificial intelligence agents used when building the inventory management application using the system for generating dynamic interactive applications is shown. For example, overall user interface wire frames are provided as a general guidance as to how the user interface will look.

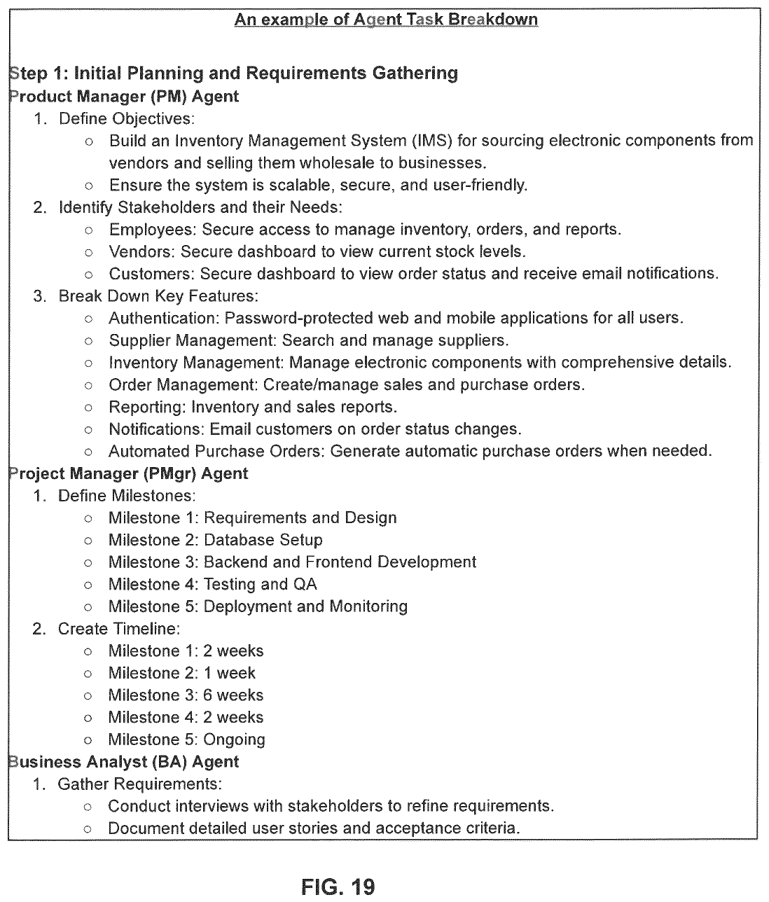

Referring to FIG. 19, an example breakdown of agent tasks used when building the inventory management application using the system for generating dynamic interactive applications is shown. For example, the stakeholders (intended users) are defined such as employees, vendors, and customers.

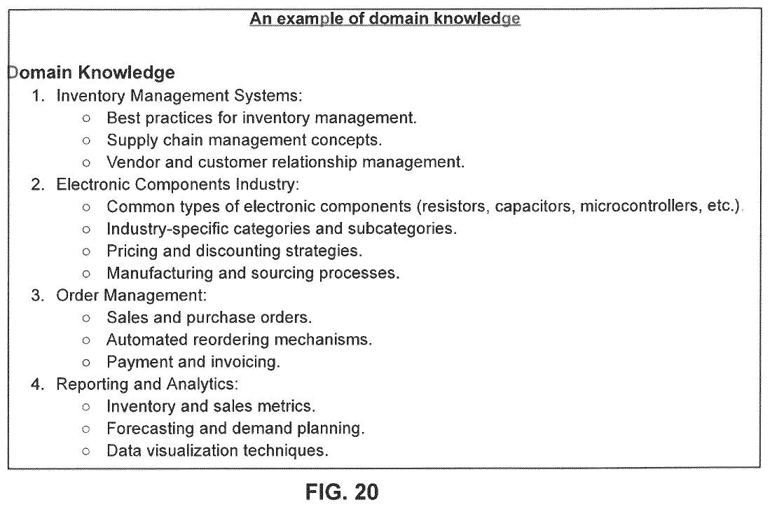

Referring to FIG. 20, an example set of domain knowledge requirements used when building the inventory management application using the system for generating dynamic interactive applications is shown. In this, existing knowledge in the area of the application is imported such as existing ordering systems, payment and invoicing.

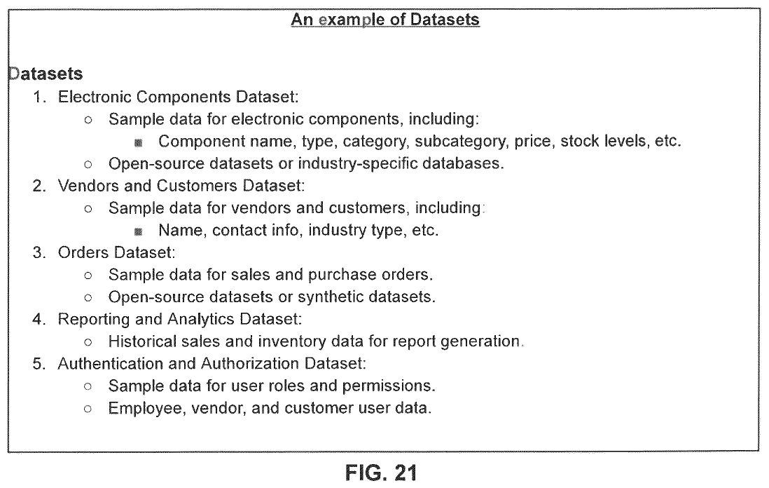

Referring to FIG. 21, an example of datasets that will be needed when building the inventory management application using the system for generating dynamic interactive applications is shown. In this, the requirements include a set of sample data that is required for each component in the dataset. For example, electronic components have a type (e.g., capacitor), sub-category (e.g., ceramic capacitor), value (e.g., 01 uF), a price, stocking level, etc.

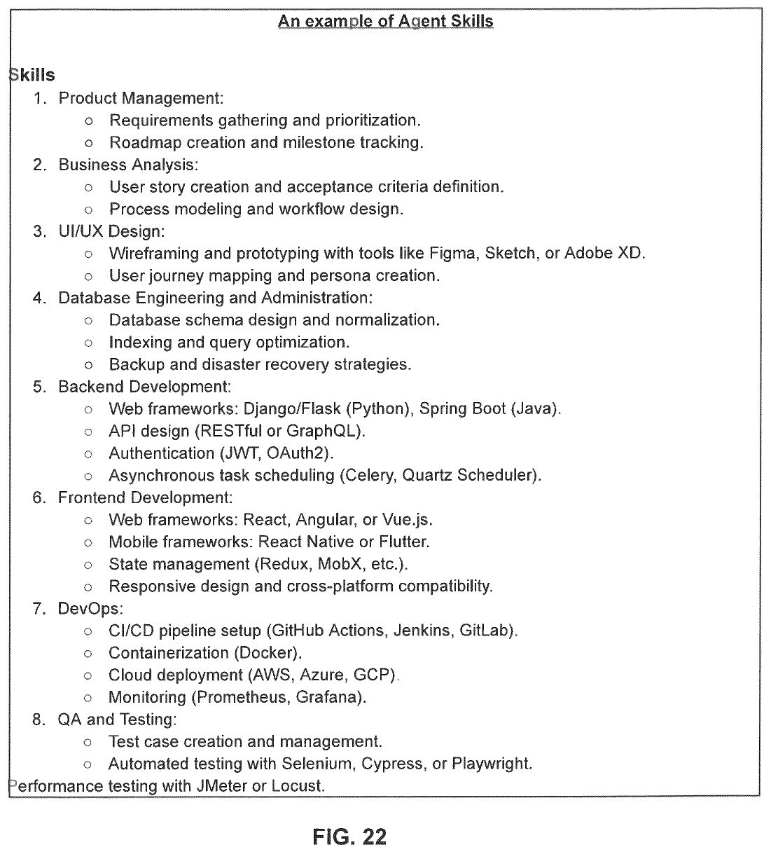

Referring to FIG. 22, an example of agent skills when building the inventory management application using the system for generating dynamic interactive applications is shown. In this, one aspect is to provide a wire frame for the user interfaces.

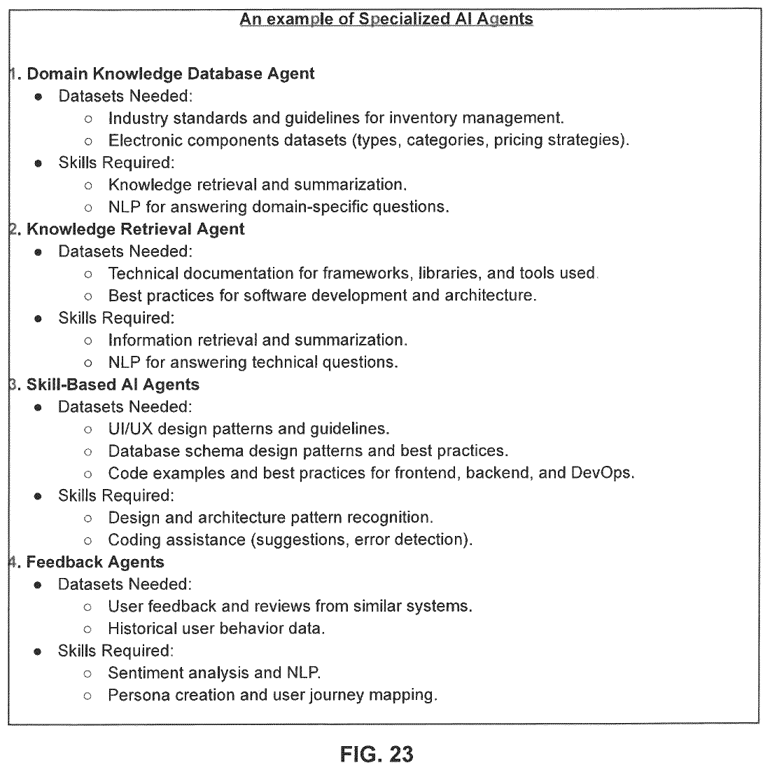

Referring to FIG. 23, an example of specialized agents used when building the inventory management application using the system for generating dynamic interactive applications is shown.

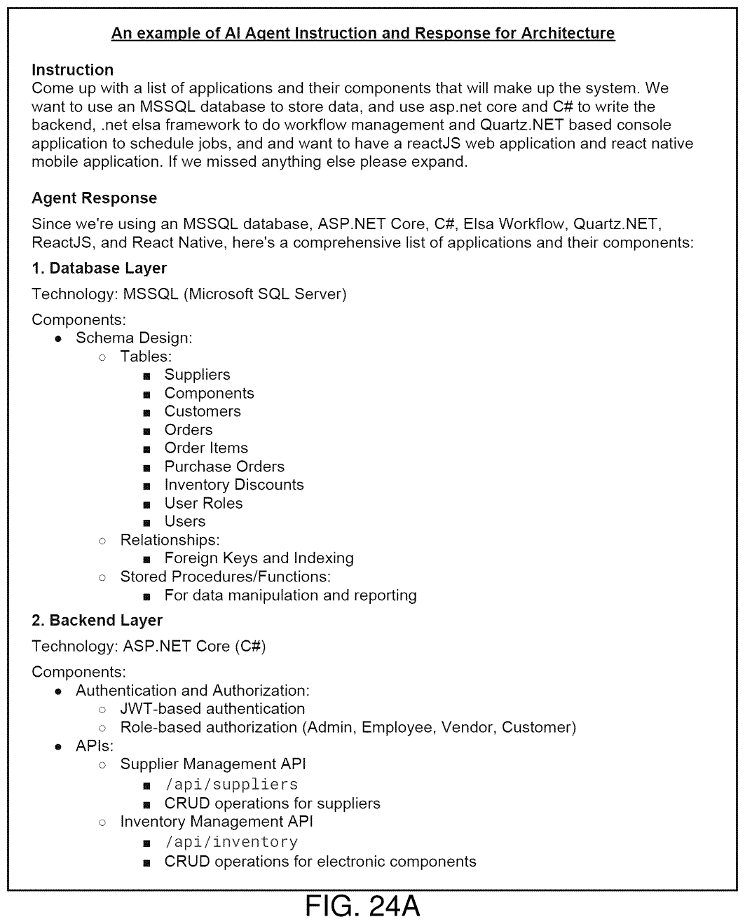

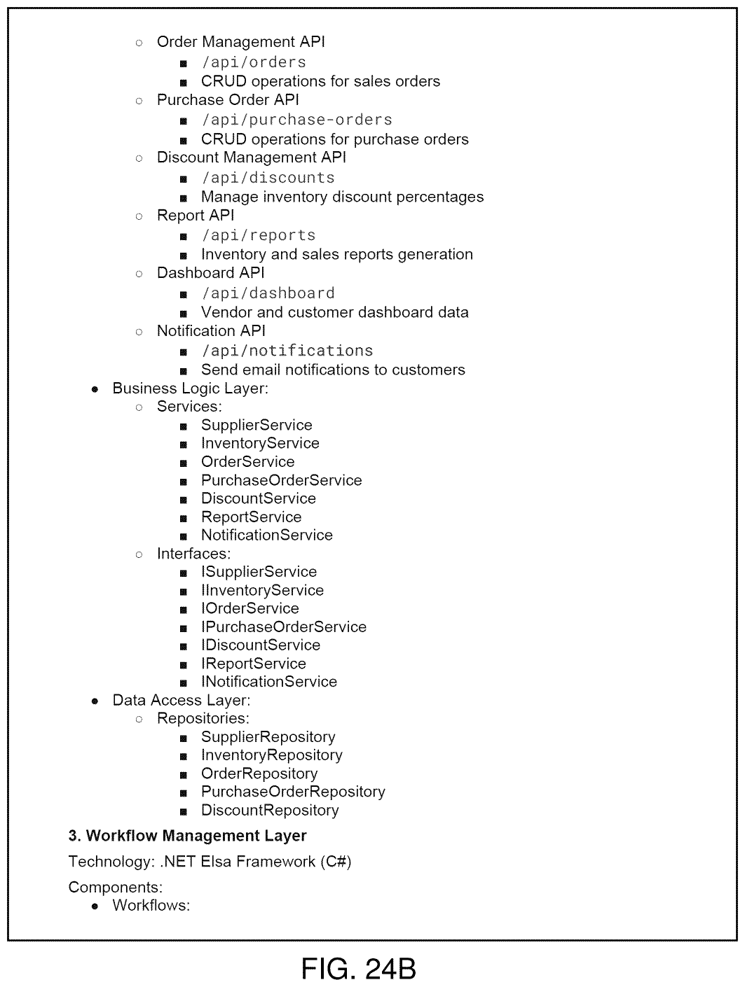

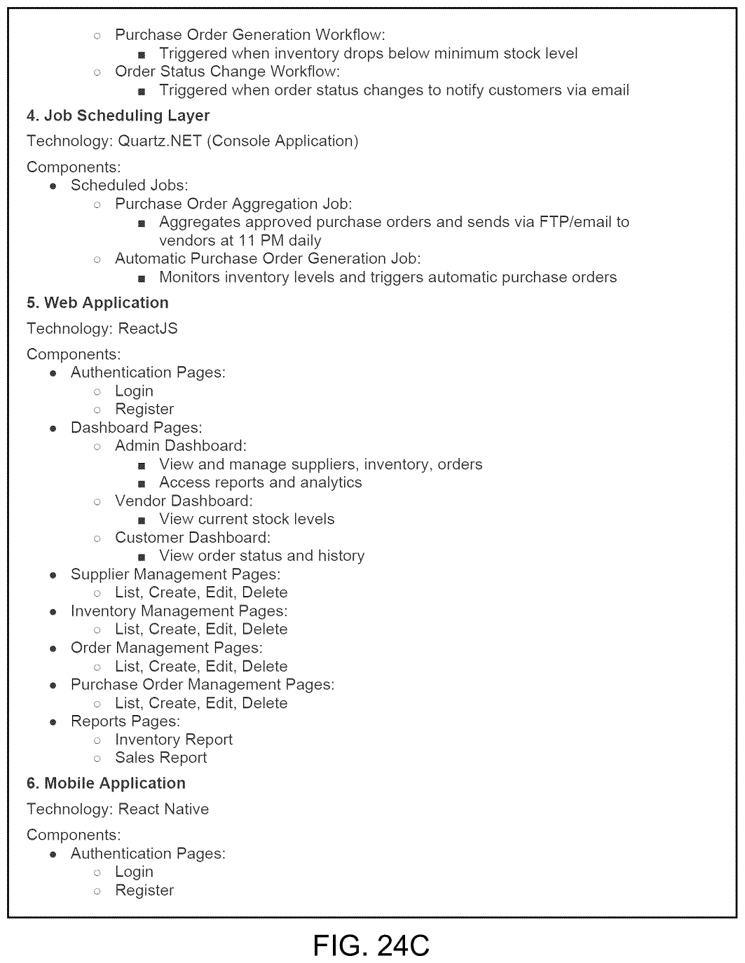

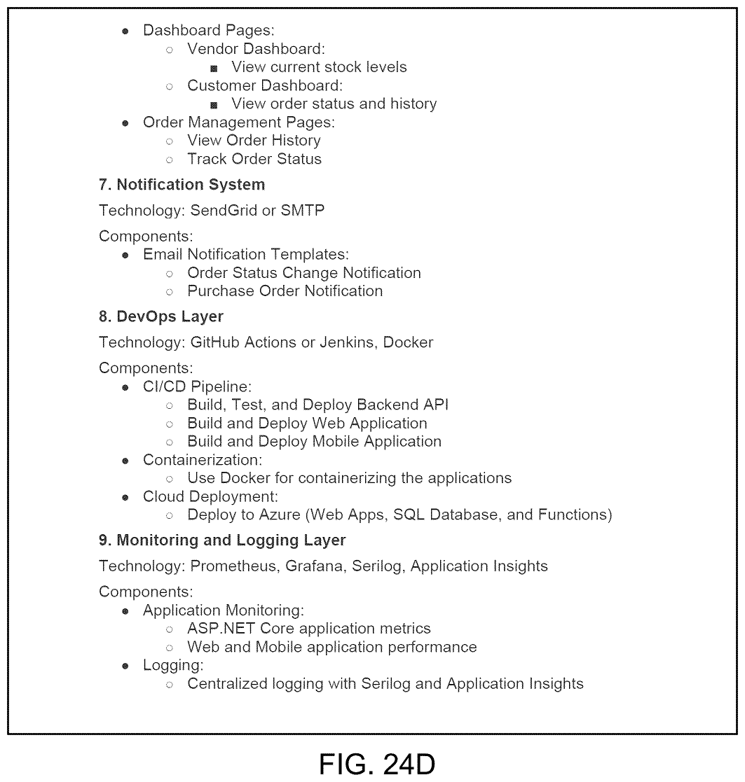

Referring to FIGS. 24A, 24B, 24C, and 24D, examples of artificial intelligence agent instructions and responses used when building the inventory management application using the system for generating dynamic interactive applications are shown. These artificial intelligence agent instructions are fed to the artificial intelligence system (e.g., GPT) to generate the application.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction, and arrangement of the components thereof without departing from the scope and spirit of the invention or without sacrificing all of its material advantages. The form herein before described being merely exemplary and explanatory embodiment thereof. It is the intention of the following claims to encompass and include such changes.

1. A method for generating and enhancing dynamic interactive applications, the method comprising:
receiving requirements for creating and/or enhancing an application, the requirements being in a natural language and/or multimedia format, receiving the requirements by way of user interfaces, the user interfaces comprising including web pages, application interfaces, image input, video input and/or voice input;
analyzing the requirements using artificial intelligence technologies including vector search, machine learning, natural language processing, and large language models to identify data sources that are necessary for querying and updating by the application, wherein the data sources include relational and non-relational databases, data lakes, data marts, data warehouses, data streams, and/or integrations;
enriching the requirements with additional information from domain-specific databases containing metadata related to the data sources, thereby creating enriched requirements;
summarizing the enriched requirements and metadata from the data sources to generate final requirements in an artificial intelligence optimized format, iteratively summarizing the enriched requirements until the enriched requirements are within processing capabilities of artificial intelligence including token limits of a large language model-based domain-specific language generator, while minimizing information loss;
generating the application in a domain-specific language using a domain-specific language generator using the artificial intelligence based on the final requirements, wherein the domain-specific language accurately and completely describes the application for understanding and generation by an application generator and the domain-specific language is designed minimizing a number of tokens needed for describing the application to conform to processing capabilities of the artificial intelligence;
deploying the application for end user use on various platforms, the various platforms including web platforms, desktop platforms, and mobile platforms;
reviewing the application through automated system and manual user reviews, ensuring that the application meets the requirements;
accepting feedback comprising user requirements and system requirements for deploying of an updated versions of the application through a feedback loop, wherein the feedback loop is provided in various formats including natural language, encoded, markup, domain-specific, or programming languages;
using version control to manage application revisions and selecting aspects of the feedback for a usable and deployable version of the application; and
continuously enhancing the application by repeating the above steps with new requirements or updated requirements.

2. The method of claim 1, wherein the domain-specific language minimizes the number of tokens needed for describing the application to conform to limitations of the artificial intelligence technologies by designing the domain-specific language to fully describe a functional application while using a least number of tokens possible.

3. The method of claim 1, further comprising using the artificial intelligence including machine learning, natural language processing, and large language models for analyzing the requirements, summarizing the requirements, and domain-specific language generation, thereby creating and enhancing the application from natural language requirements in a dynamic interactive format.

4. The method of claim 1, wherein enriching requirements includes querying domain-specific databases containing metadata related to the data sources including relational and non-relational databases, data lakes, data marts, data warehouses, data streams, application programming interfaces, and integrations, to provide additional context and information for generating the application.

5. The method of claim 1, wherein the dynamic interactive applications are composed of dashboards that include widgets, filters, actions, and links, all arranged in an optimal way for user interaction and data manipulation, and the dashboards receive data from configured data sources in real-time and allow users to update the data through action elements.

6. The method of claim 1, wherein the application supports multiple layouts and themes that are customizable and optimized for different devices, allowing operation across a plurality of platforms.

7. The method of claim 1, further comprising creating jobs for automated actions comprising data import, data export, and data transformation, the jobs are defined within the application based on the requirements and the jobs are pre-configured to perform specific tasks.

8. A system for generating and enhancing dynamic interactive applications comprising:
a requirements receiver configured to receive application requirements in a natural language format from user interfaces, the user interfaces including web pages, application interfaces, and voice input;
an artificial intelligence based requirements pre-processor analyzes and splits requirements using artificial intelligence technologies, the artificial intelligence technologies comprise machine learning, natural language processing, and large language models, to identify data sources that are relevant;
a domain-specific database enhancer enriches the requirements with domain-specific metadata from databases containing information related to the data sources that are identified;
a requirements summarizer utilizes the artificial intelligence technologies to create summarized requirements within artificial intelligence processing limits, the requirements summarizer iterates multiple times to ensure the requirements meet an artificial intelligence processor token limit without significant information loss;
an artificial intelligence technologies domain-specific language code generator creates an application in a domain-specific language based on the summarized requirements, wherein the artificial intelligence technologies domain-specific language code generator uses a multimodal large language model that understands the domain-specific language and generates domain-specific language instructions for application development;
an application builder converts the domain-specific language instructions into a deployable functional application including a dashboard configuration database and stores details related to dashboard configurations, widgets, filters, actions, and links;
a version control system manages revisions of the application and selects aspects of the revisions for a usable and deployable version of the application; and
a feedback receiver processes additional user requirements and system requirements to enhance the application, the feedback receiver accepts the requirements in various formats including natural language, encoded, markup, domain-specific, and/or programming languages for comprehensive application enhancements based on wide-ranging feedback types.

9. The system of claim 8, wherein the artificial intelligence technologies domain-specific language code generator is constructed using a multimodal large language model that understands and generates the domain-specific language instructions for application development and ensures that the domain-specific language instructions that are generated conforms to the requirements of the system for generating and enhancing dynamic interactive applications and accurately describes the application.

10. The system of claim 8, wherein the application builder includes the dashboard configuration database comprising the details related to the dashboard configurations, widgets, filters, actions, and links, the details used to generate functional applications that run on various platforms, including web platforms, desktop platforms, and mobile platforms.

11. The system of claim 8, wherein the requirements summarizer iterates multiple times to ensure the requirements meet a token limit of the artificial intelligence technologies without significant information loss and adjusts the system for generating and enhancing dynamic interactive applications to preserve essential information while reducing a number of tokens.

12. The system of claim 8, wherein the feedback receiver accepts the requirements in various formats including natural language, encoded, markup, domain-specific, or programming languages; for enhancements to the application based on wide-ranging feedback types, providing for continuous improvement of the application.
